(19) United States
(12) Patent Application Publication
(10) Pub. No.: US 2025/0070874 A1
(43) Pub. Date: Feb. 27, 2025

(54) FEEDBACK FOR VISIBLE LIGHT COMMUNICATION TRANSMISSIONS

(71) Applicant: QUALCOMM Incorporated, San Diego, CA (US)

(72) Inventors: Kangqi LIU, San Diego, CA (US); Chao WEI, Beijing (CN); Jing DAI, Beijing (CN); Hao XU, Beijing (CN)

(21) Appl. No.: 18/684,085

(22) PCT Filed: Oct. 26, 2021
(86) PCT No.: PCT/CN2021/126291

§ 371 Date: Feb. 15, 2024

(51) Int. Cl. H04B 10/116; H04B 10/27; H04L 1/1812; H04L 5/00

(52) U.S. Cl. CPC H04B 10/116; H04B 10/27; H04L 1/1812; H04L 5/0055

(57) ABSTRACT

Various aspects of the present disclosure generally relate to wireless communication. In some aspects, a user equipment (UE) may receive, from a base station, a downlink visible light communication (VLC) transmission. The UE may receive, from the base station, a downlink New Radio (NR) radio frequency (RF)-based communication (RFC) transmission, wherein a frame structure associated with the downlink VLC transmission is asynchronous with a frame structure associated with the downlink NR RFC transmission. The UE may transmit, to the base station via an uplink RF transmission based at least in part on a lack of support for an uplink VLC transmission at the UE, acknowledgement or negative acknowledgement (ACK/NACK) feedback associated with one or more of the downlink VLC transmission or the downlink NR RFC transmission. Numerous other aspects are described.

### FIELD OF THE DISCLOSURE

Aspects of the present disclosure generally relate to wireless communication and to techniques and apparatuses for feedback for visible light communication (VLC) transmissions.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some implementations, an apparatus for wireless communication at a user equipment (UE) includes a photo detector or an image sensor; a transceiver; a memory: and one or more processors, coupled to the memory, configured to: receive, from a base station via the photo detector or the image sensor, a downlink visible light communication (VLC) transmission; receive, from the base station via the transceiver, a downlink New Radio (NR) radio frequency (RF) based communication (RFC) transmission, wherein a frame structure associated with the downlink VLC transmission is asynchronous with a frame structure associated with the downlink NR RFC transmission; and transmit, to the base station via the transceiver and via an uplink RF transmission based at least in part on a lack of support for an uplink VLC transmission at the UE, acknowledgement or negative acknowledgement (ACK/NACK) feedback associated with one or more of the downlink VLC transmission or the downlink NR RFC transmission.

In some implementations, an apparatus for wireless communication at a base station includes a light emitting diode (LED) or a laser diode; a transceiver; a memory; and one or more processors, coupled to the memory, configured to: transmit, to a UE via the LED or the laser diode, a downlink VLC transmission; transmit, to the UE via the transceiver, a downlink NR RFC transmission, wherein a frame structure associated with the downlink VLC transmission is asynchronous with a frame structure associated with the downlink NR RFC transmission; and receive, from the UE via the transceiver and via an uplink RF transmission based at least in part on a lack of support for an uplink VLC transmission at the UE, ACK/NACK feedback associated with one or more of the downlink VLC transmission or the downlink NR RFC transmission.

In some implementations, a method of wireless communication performed by a UE includes receiving, from a base station, a downlink VLC transmission; receiving, from the base station, a downlink NR RFC transmission, wherein a frame structure associated with the downlink VLC transmission is asynchronous with a frame structure associated with the downlink NR RFC transmission; and transmitting, to the base station via an uplink RF transmission based at least in part on a lack of support for an uplink VLC transmission at the UE, ACK/NACK feedback associated with one or more of the downlink VLC transmission or the downlink NR RFC transmission.

In some implementations, a method of wireless communication performed by a base station includes transmitting, to a UE, a downlink VLC transmission; transmitting, to the UE, a downlink NR RFC transmission, wherein a frame structure associated with the downlink VLC transmission is asynchronous with a frame structure associated with the downlink NR RFC transmission; and receiving, from the UE via an uplink RF transmission based at least in part on a lack of support for an uplink VLC transmission at the UE, ACK/NACK feedback associated with one or more of the downlink VLC transmission or the downlink NR RFC transmission.

In some implementations, a non-transitory computer-readable medium storing a set of instructions for wireless communication includes one or more instructions that, when executed by one or more processors of a UE, cause the UE to: receive, from a base station, a downlink VLC transmission; receive, from the base station, a downlink NR RFC transmission, wherein a frame structure associated with the downlink VLC transmission is asynchronous with a frame structure associated with the downlink NR RFC transmission; and transmit, to the base station via an uplink RF transmission based at least in part on a lack of support for an uplink VLC transmission at the UE, ACK/NACK feedback associated with one or more of the downlink VLC transmission or the downlink NR RFC transmission.

In some implementations, a non-transitory computer-readable medium storing a set of instructions for wireless communication includes one or more instructions that, when executed by one or more processors of a base station, cause the base station to: transmit, to a UE, a downlink VLC transmission; transmit, to the UE, a downlink NR RFC transmission, wherein a frame structure associated with the downlink VLC transmission is asynchronous with a frame structure associated with the downlink NR RFC transmission; and receive, from the UE via an uplink RF transmission based at least in part on a lack of support for an uplink VLC transmission at the UE, ACK/NACK feedback associated with one or more of the downlink VLC transmission or the downlink NR RFC transmission.

In some implementations, an apparatus for wireless communication includes means for receiving, from a base station, a downlink VLC transmission; means for receiving, from the base station, a downlink NR RFC transmission, wherein a frame structure associated with the downlink VLC transmission is asynchronous with a frame structure associated with the downlink NR RFC transmission; and means for transmitting, to the base station via an uplink RF transmission based at least in part on a lack of support for an uplink VLC transmission at the apparatus, ACK/NACK feedback associated with one or more of the downlink VLC transmission or the downlink NR RFC transmission.

In some implementations, an apparatus for wireless communication includes means for transmitting, to a UE, a downlink VLC transmission; means for transmitting, to the UE, a downlink NR RFC transmission, wherein a frame structure associated with the downlink VLC transmission is asynchronous with a frame structure associated with the downlink NR RFC transmission; and means for receiving, from the UE via an uplink RF transmission based at least in part on a lack of support for an uplink VLC transmission at the UE, ACK/NACK feedback associated with one or more of the downlink VLC transmission or the downlink NR RFC transmission.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of a visible light communication (VLC) system, in accordance with the present disclosure.

FIGS. 4-7 are diagrams illustrating examples associated with feedback for VLC transmissions, in accordance with the present disclosure.

FIGS. 8-9 are diagrams illustrating example processes associated with feedback for VLC transmissions, in accordance with the present disclosure.

FIGS. 10-11 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

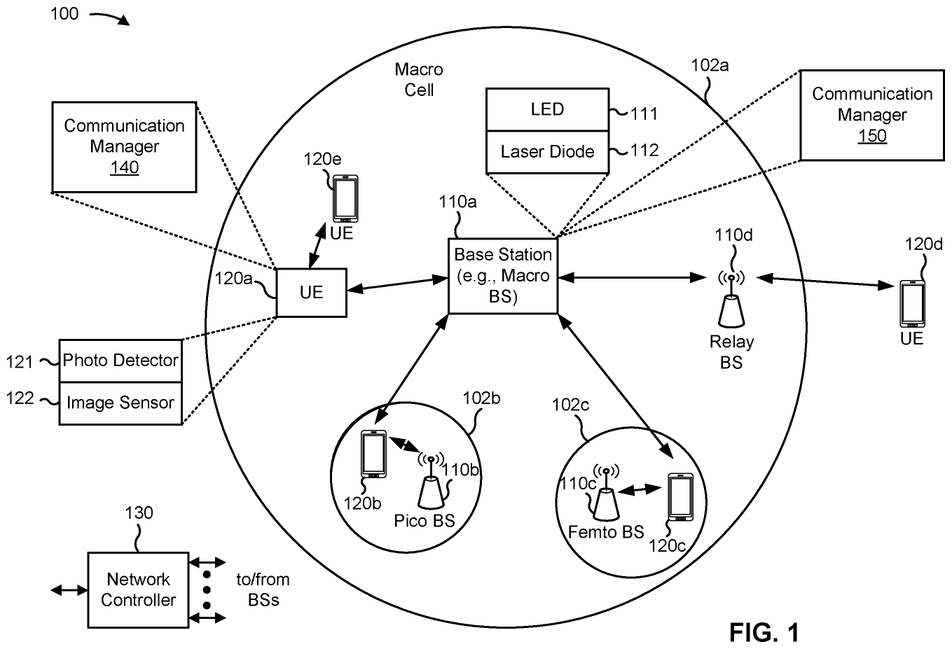

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum in the radio frequency (RF) range, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., UE 120) may include a communication manager 140. As described in more detail elsewhere herein, the communication manager 140 may receive via a photo detector 121 or an image sensor 122, from a base station, a downlink visible light communication (VLC) transmission; receive, from the base station, a downlink NR RF-based communication (RFC) transmission, wherein a frame structure associated with the downlink VLC transmission is asynchronous with a frame structure associated with the downlink NR RFC transmission; and transmit, to the base station via an uplink RF transmission based at least in part on a lack of support for an uplink VLC transmission at the UE, acknowledgement or negative acknowledgement (ACK/NACK) feedback associated with one or more of the downlink VLC transmission or the downlink NR RFC transmission. Additionally, or alternatively, the communication manager 140 may perform one or more other operations described herein.

In some aspects, a base station (e.g., base station 110) may include a communication manager 150. As described in more detail elsewhere herein, the communication manager 150 may transmit via a light emitting diode (LED) 111 or a laser diode 112, to a UE, a downlink VLC transmission; transmit, to the UE, a downlink NR RFC transmission, wherein a frame structure associated with the downlink VLC transmission is asynchronous with a frame structure associated with the downlink NR RFC transmission; and receive, from the UE via an uplink RF transmission based at least in part on a lack of support for an uplink VLC transmission at the UE, ACK/NACK feedback associated with one or more of the downlink VLC transmission or the downlink NR RFC transmission. Additionally, or alternatively, the communication manager 150 may perform one or more other operations described herein.

As indicated above, FIG. 1 is provided as an example. Other examples may differ from what is described with regard to FIG. 1.

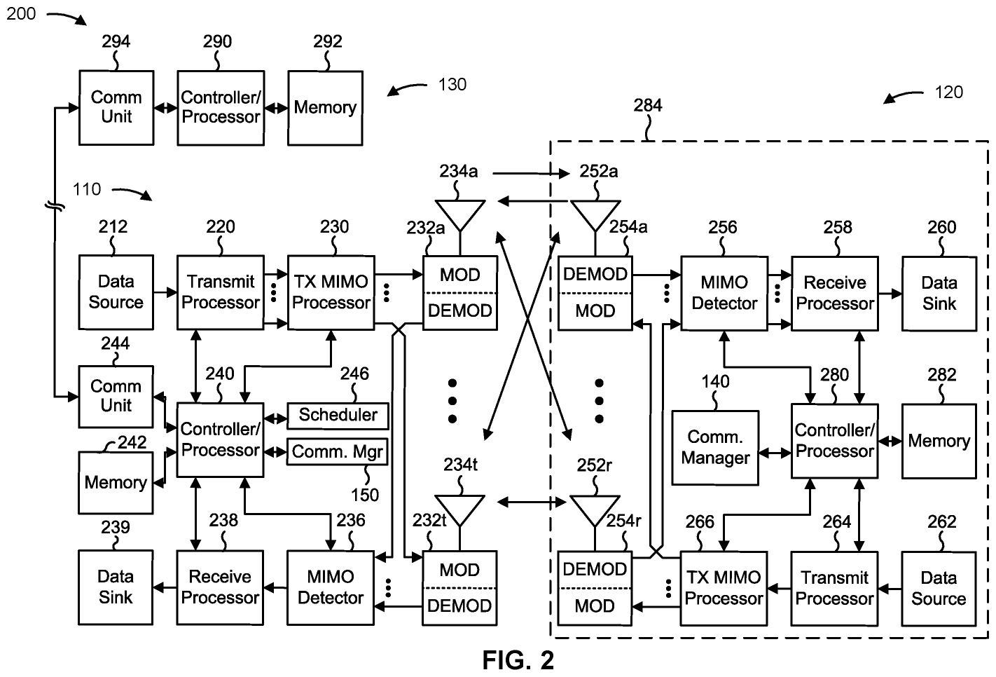

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The UE 120 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

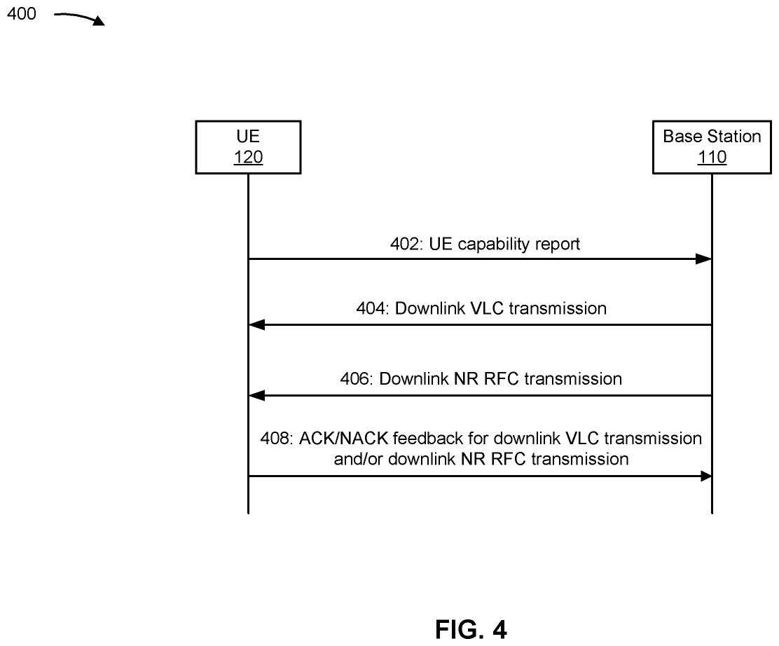

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-11).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-11).

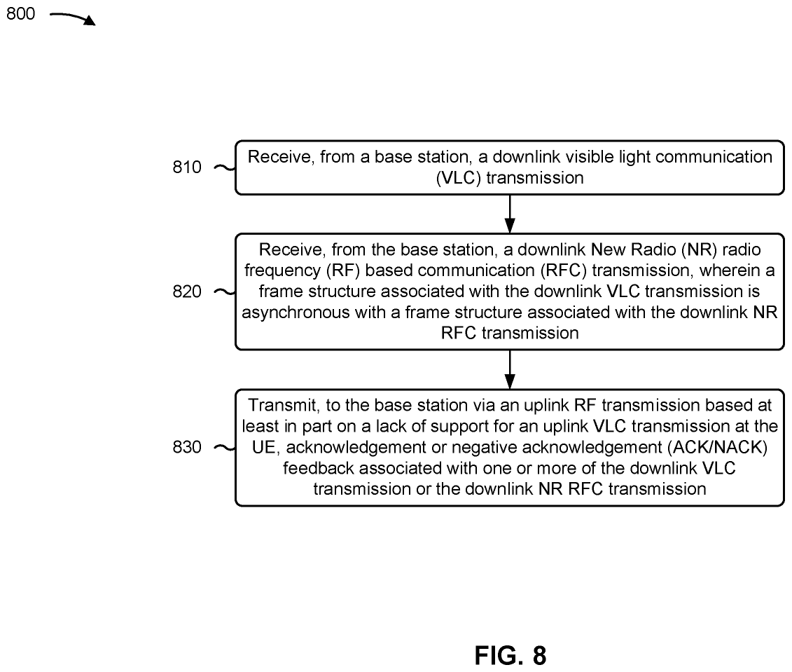

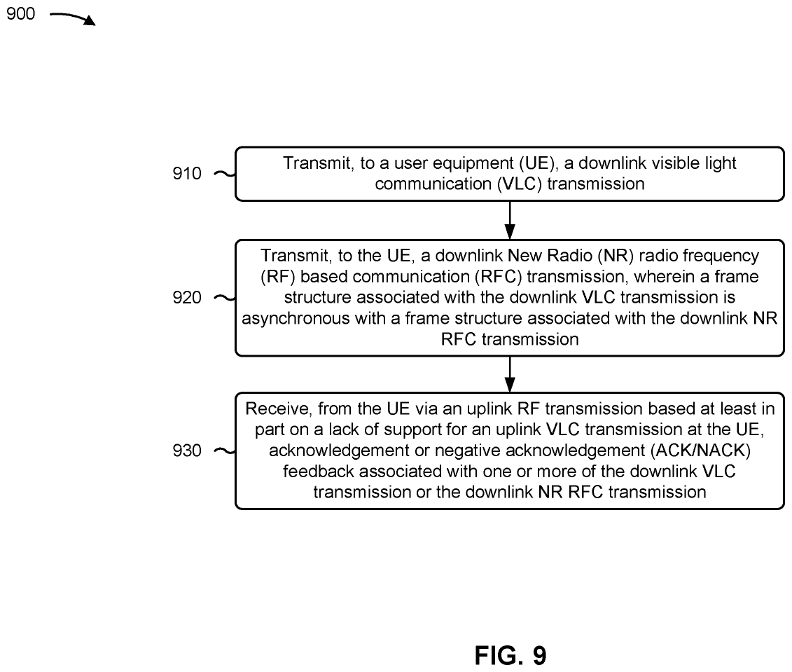

The controller/processor 240 of the base station 110, the controller/processor 280 of the UE 120, and/or any other component(s) of FIG. 2 may perform one or more techniques associated with feedback for VLC transmissions, as described in more detail elsewhere herein. For example, the controller/processor 240 of the base station 110, the controller/processor 280 of the UE 120, and/or any other component(s) of FIG. 2 may perform or direct operations of, for example, process 800 of FIG. 8, process 900 of FIG. 9, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 800 of FIG. 8, process 900 of FIG. 9, and/or other processes as described herein. In some examples, executing instructions may include running the instructions, converting the instructions, compiling the instructions, and/or interpreting the instructions, among other examples.

In some aspects, a UE (e.g., UE 120) includes means for receiving, from a base station, a downlink VLC transmission (e.g., using receive processor 258, controller/processor 280, memory 282, photo detector 121 (as shown in FIG. 1 and which may, for example, be in communication with receive processor 258 and/or controller/processor 280), and/or image sensor 122 (as shown in FIG. 1 and which may, for example, be in communication with receive processor 258 and/or controller/processor 280)); means for receiving, from the base station, a downlink NR RFC transmission, wherein a frame structure associated with the downlink VLC transmission is asynchronous with a frame structure associated with the downlink NR RFC transmission (e.g., using antenna 252, modem 254, MIMO detector 256, receive processor 258, controller/processor 280, and/or memory 282); and/or means for transmitting, to the base station via an uplink RF transmission based at least in part on a lack of support for an uplink VLC transmission at the UE, ACK/NACK feedback associated with one or more of the downlink VLC transmission or the downlink NR RFC transmission (e.g., using controller/processor 280, transmit processor 264, TX MIMO processor 266, modem 254, antenna 252, and/or memory 282). The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a base station (e.g., base station 110) includes means for transmitting, to a UE, a downlink VLC transmission (e.g., using controller/processor 240, transmit processor 220, memory 242, LED 111 (as shown in FIG. 1 and which may, for example, be in communication with controller/processor 240, transmit processor 220), and/or laser diode 112 (as shown in FIG. 1 and which may, for example, be in communication with controller/processor 240, transmit processor 220)); means for transmitting, to the UE, a downlink NR RFC transmission, wherein a frame structure associated with the downlink VLC transmission is asynchronous with a frame structure associated with the downlink NR RFC transmission (e.g., using controller/processor 240, transmit processor 220, TX MIMO processor 230, modem 232, antenna 234, and/or memory 242); and/or means for receiving, from the UE via an uplink RF transmission based at least in part on a lack of support for an uplink VLC transmission at the UE, ACK/NACK feedback associated with one or more of the downlink VLC transmission or the downlink NR RFC transmission (e.g., using antenna 234, modem 232, MIMO detector 236, receive processor 238, controller/processor 240, and/or memory 242). The means for the base station to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Visible light communications (VLCs) may be an alternative to radio-based communications, especially for indoor communications. A VLC transmitter may transmit data via an LED that varies in intensity. A VLC receiver may include a photo detector that detects light emitted from the VLC transmitter. The VLC receiver may produce an electrical signal composed of a message and noise based at least in part on the light detected via the photo detector. The photo detector in the VLC receiver may be a photo diode or an image sensor.

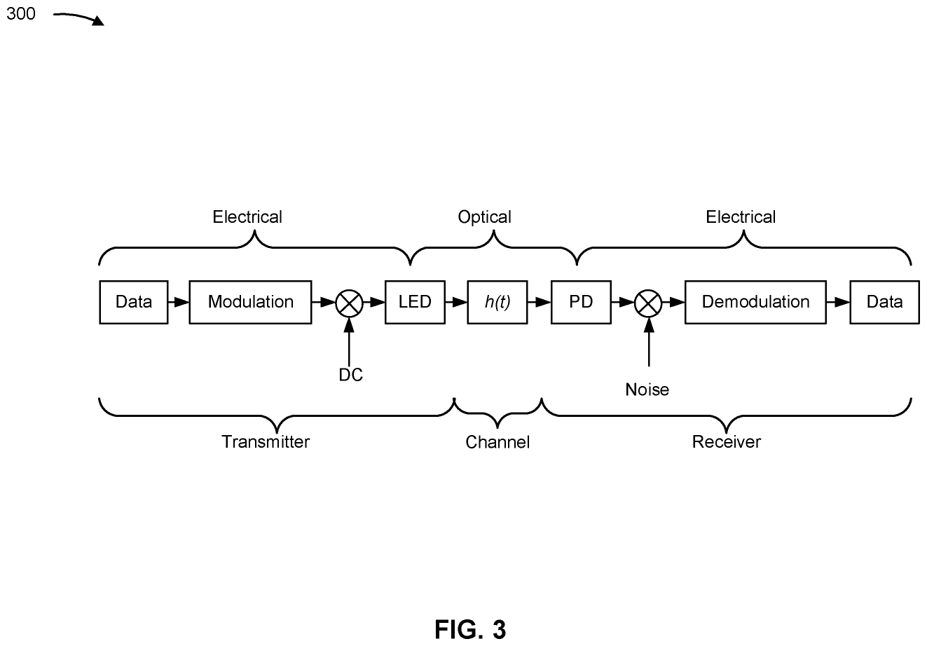

FIG. 3 is a diagram illustrating an example 300 of a VLC system, in accordance with the present disclosure.

As shown in FIG. 3, the VLC system may include a VLC transmitter and a VLC receiver. A channel represented by h(t) may separate the VLC transmitter and the VLC receiver. The VLC transmitter may perform a modulation on data to form modulated data. The modulated data may be provided to an LED, which may produce an optical signal based at least in part on the modulated data. The optical signal may be a series of light emissions at various intensities, which may represent the optical signal. The optical signal may be transmitted through the channel between the VLC transmitter and the VLC receiver. The optical signal may be detected at a photo detector (PD) of the VLC receiver. The VLC receiver may remove noise from the optical signal detected at the photo detector. The VLC receiver may further perform a demodulation to produce the data. The data produced after the demodulation at the VLC receiver may correspond to the data present at the VLC transmitter prior to the modulation performed at the VLC transmitter.

As indicated above, FIG. 3 is provided as an example. Other examples may differ from what is described with regard to FIG. 3.

A UE (e.g., a smartphone or watch) may be equipped with a photo detector and/or an image sensor (e.g., as part of a camera of the UE), which may be used to receive downlink VLC transmissions. The UE may support downlink VLC transmissions but not uplink VLC transmissions. When the UE supports the downlink VLC transmissions but not the uplink VLC transmissions, a reliability of the downlink VLC transmissions cannot be guaranteed due to a lack of feedback signaling in VLC. In other words, the reliability of the downlink VLC transmissions may not be guaranteed since the UE may not support uplink VLC transmissions for feedback signaling. The feedback signaling may involve the UE indicating an ACK or a NACK based at least in part on the downlink VLC transmissions. The UE may be unable to perform the feedback signaling when the uplink VLC transmissions are not supported.

In various aspects of techniques and apparatuses described herein, a UE may receive, from a base station, a downlink VLC transmission. The UE may receive, from the base station, a downlink NR RFC transmission. A frame structure associated with the downlink VLC transmission may be asynchronous with a frame structure associated with the downlink NR RFC transmission. The UE may transmit, to the base station via an uplink RF transmission, ACK/NACK feedback associated with the downlink VLC transmission and/or the downlink NR RFC transmission. The UE may transmit the ACK/NACK feedback via the uplink RF transmission based at least in part on a lack of support for an uplink VLC transmission at the UE. In some aspects, the UE may be configured for NR-VLC dual connectivity and/or NR-VLC carrier aggregation. The UE may transmit the ACK/NACK feedback for the downlink VLC transmission and/or the downlink NR RFC transmission, which may improve a reliability of the downlink VLC transmission for the UE that does not support the uplink VLC transmission.

In some aspects, the UE may support a coexistence of VLC and NR based at least in part on an asynchronous signaling design, due to the different frame structure and (e.g., a different frame length) for VLC as compared to NR. The UE may support VLC-NR dual connectivity and VLC-NR carrier aggregation, which may allow the UE to provide feedback via NR when the UE does not support uplink VLC transmissions. As a result, the UE may support a higher reliability for the downlink VLC transmission. Further, transmitting the feedback for the downlink VLC transmissions via NR would not be apparent due to the different frame structure and the different frame length for VLC as compared to NR, which necessitates the asynchronized signaling design.

FIG. 4 is a diagram illustrating an example 400 associated with feedback for VLC transmissions, in accordance with the present disclosure. As shown in FIG. 4, example 400 includes communication between a UE (e.g., UE 120) and a base station (e.g., base station 110). In some aspects, the UE and the base station may be included in a wireless network, such as wireless network 100.

As shown by reference number 402, the UE may transmit via a transceiver of the UE, to the base station, a UE capability report that includes a first parameter and a second parameter. The first parameter may indicate that the UE supports a downlink VLC transmission and the second parameter may indicate that the UE does not support an uplink VLC transmission. In some aspects, the UE may be configured for an NR-VLC carrier aggregation or an NR-VLC dual connectivity.

In some aspects, a UE capability information element (IE) may indicate two parameters associated with the UE reporting whether downlink VLC transmissions and/or uplink VLC transmissions are supported or not. The first parameter may indicate to the base station whether the downlink VLC transmissions are supported. The second parameter may indicate to the base station whether the uplink VLC transmissions are supported. In some aspects, the UE capability IE may include the first parameter, which may indicate that the UE supports the downlink VLC transmissions, and the UE capability IE may include the second parameter, which may indicate that the UE does not support the uplink VLC transmissions.

In some aspects, the UE capability report may indicate a maximum supported quantity of hybrid automatic repeat request (HARQ) processes. In some aspects, the UE capability report may indicate a maximum quantity of HARQ processes for both downlink NR RFC transmissions and downlink VLC transmissions. In some aspects, the UE capability report may indicate a first quantity indicating a maximum quantity of HARQ processes for downlink NR RFC transmissions and a second quantity indicating a maximum quantity of HARQ processes for downlink VLC transmissions. In some aspects, the UE capability report may indicate a first quantity indicating a maximum quantity of HARQ processes for both downlink NR RFC transmissions and downlink VLC transmissions, and a second quantity indicating a maximum quantity of HARQ processes for downlink VLC transmissions. In some aspects, the UE capability report may indicate a first quantity indicating a maximum quantity of HARQ processes for both downlink NR RFC transmissions and downlink VLC transmissions, and a second quantity indicating a maximum quantity of HARQ processes for downlink NR RFC transmissions.

In some aspects, a larger quantity of maximum HARQ processes may be considered for VLC as compared to NR, especially when a backhaul delay is relatively large between NR and VLC. The UE may transmit, to the base station, the UE capability report that indicates the maximum quantity of HARQ processes that are supported by the UE. In some aspects, the UE capability report may indicate the maximum quantity of HARQ processes for both downlink NR RFC transmissions and downlink VLC transmissions. In some aspects, the UE capability report may indicate the first quantity indicating the maximum quantity of HARQ processes for the downlink NR RFC transmissions and the second quantity indicating the maximum quantity of HARQ processes for the downlink VLC transmissions. In some aspects, the UE capability report may indicate the first quantity indicating the maximum quantity of HARQ processes for both downlink NR RFC transmissions and downlink VLC transmissions, and the second quantity indicating the maximum quantity of HARQ processes for the downlink VLC transmissions. In some aspects, the UE capability report may indicate the first quantity indicating the maximum quantity of HARQ processes for both downlink NR RFC transmissions and downlink VLC transmissions, and the second quantity indicating the maximum quantity of HARQ processes for the downlink NR RFC transmissions.

As shown by reference number 404, the UE may receive, from the base station, the downlink VLC transmission. The UE may receive the downlink VLC transmission based at least in part on the UE capability report. The UE may receive the downlink VLC transmission via a photodetector or an image sensor of the UE. The base station may transmit the downlink VLC transmission via a light emitting diode or a laser diode of the base station.

As shown by reference number 406, the UE may receive via the transceiver of the UE, from the base station, a downlink NR RFC transmission. A frame structure associated with the downlink VLC transmission may be asynchronous with a frame structure associated with the downlink NR RFC transmission. In other words, the frame structure associated with the downlink VLC transmission may not be synchronized with the frame structure associated with the downlink NR RFC transmission.

In some aspects, the base station may transmit the downlink VLC transmission and the downlink NR RFC transmission. In other words, a same base station may transmit the downlink VLC transmission and the downlink NR RFC transmission. In some aspects, based at least in part on a centralized unit (CU), distributed unit (DU), and radio unit (RU) split of the base station, the CU and the DU may be common for the downlink VLC transmission and the downlink NR RFC transmission. In some cases, the downlink VLC transmission may use an appropriate unit for VLC communication and the downlink NR RFC transmission may use an RU that is separate from the unit used for the VLC communication.

As shown by reference number 408, the UE may transmit via the transceiver of the UE, to the base station via an uplink RF transmission based at least in part on a lack of support for an uplink VLC transmission at the UE, ACK/NACK feedback associated with the downlink VLC transmission and/or the downlink NR RFC transmission. The UE may transmit the ACK/NACK feedback via the uplink RF transmission and not via the uplink VLC transmission, which may not be supported at the UE.

In some aspects, the UE may transmit a MAC-CE that indicates the ACK/NACK feedback for the downlink VLC transmission and not for the downlink NR RFC transmission. The MAC-CE may be configured in a semi-persistent scheduling (SPS) configuration IE based at least in part on the UE being configured with an SPS downlink VLC transmission. The MAC-CE may be triggered by a medium access control (MAC) transmit entity at the base station based at least in part on the downlink VLC transmission being dynamically scheduled for the UE. In some aspects, the UE may transmit, for a HARQ process, the ACK/NACK feedback that bundles feedback for both the downlink VLC transmission and the downlink NR RFC transmission. The downlink NR RFC transmission and the downlink VLC transmission may be associated with a same MAC entity of the UE.

In some aspects, the ACK/NACK feedback may be associated with a first HARQ-ACK codebook for the downlink VLC transmission and a second HARQ-ACK codebook for the downlink NR RFC transmission. In some aspects, the ACK/NACK feedback may be associated with a single HARQ-ACK codebook for both the downlink VLC transmission and the downlink NR RFC transmission. In some aspects, the ACK/NACK feedback may be associated with a single HARQ-ACK codebook for both the downlink VLC transmission and the downlink NR RFC transmission, where a downlink assignment indicator (DAI) that is indexed based at least in part on a slot beginning boundary is separately indexed for the downlink VLC transmission and the downlink NR RFC transmission.

In some aspects, a HARQ-ACK codebook type may be separately configured for the downlink VLC transmission and the downlink NR RFC transmission based at least in part on the ACK/NACK feedback being a layer 1 (L1) ACK/NACK feedback. The two separate HARQ-ACK codebooks may be fed back via the uplink RF transmission. The two separate HARQ-ACK codebooks may include a dynamic codebook for the downlink NR RFC transmission and a semi-static codebook for the downlink VLC transmission. The two separate HARQ-ACK codebooks may include a dynamic codebook for the downlink NR RFC transmission and a dynamic codebook for the downlink VLC transmission. The two separate HARQ-ACK codebooks may include a semi-static codebook for the downlink NR RFC transmission and a semi-static codebook for the downlink VLC transmission. The two separate HARQ-ACK codebooks may include a semi-static codebook for the downlink NR RFC transmission and a dynamic codebook for the downlink VLC transmission.

In some aspects, the DAI, including a counter downlink assignment index (cDAI) and a total downlink assignment index (tDAI), may be indexed based at least in part on a slot beginning boundary. A dedicated HARQ-ACK codebook may contain feedback of transport blocks (TBs), which may finish a transmission before an uplink slot beginning boundary. In some aspects, the HARQ-ACK codebook for RF and VLC may be separated (e.g., two codebooks). In some aspects, the HARQ-ACK codebook for RF and VLC may be combined (e.g., one codebook). In some examples, the DAI for RF and VLC may be separately indexed, but a single HARQ-ACK codebook may be used. The dedicated HARQ-ACK codebooks for bundled NR and VLC feedback may support the higher reliability of the downlink VLC transmission.

In some aspects, when the L1 ACK/NACK feedback is used for VLC, two HARQ-ACK codebook types may be separately configured for RFC and VLC. The two separate HARQ-ACK codebooks may be fed back through separate uplink RF transmissions. In some aspects, a dynamic codebook may be used for NR and a semi-static codebook may be used for VLC. In some aspects, a dynamic codebook may be used for NR and a dynamic codebook may be used for VLC. In some aspects, a semi-static codebook may be used for NR and a semi-static codebook may be used for VLC. In some aspects, a semi-static codebook may be used for NR and a dynamic codebook may be used for VLC.

In some aspects, the UE may transmit, for each radio link control (RLC) protocol data unit (PDU), the ACK/NACK feedback in an RLC status PDU that bundles feedback for both the downlink VLC transmission and the downlink NR RFC transmission. The RLC status PDU may be based at least in part on data received from an RF MAC entity of the UE and a VLC MAC entity of the UE. The downlink NR RFC transmission and the downlink VLC transmission may be associated with a same RLC entity of the UE.

As indicated above, FIG. 4 is provided as an example. Other examples may differ from what is described with regard to FIG. 4.

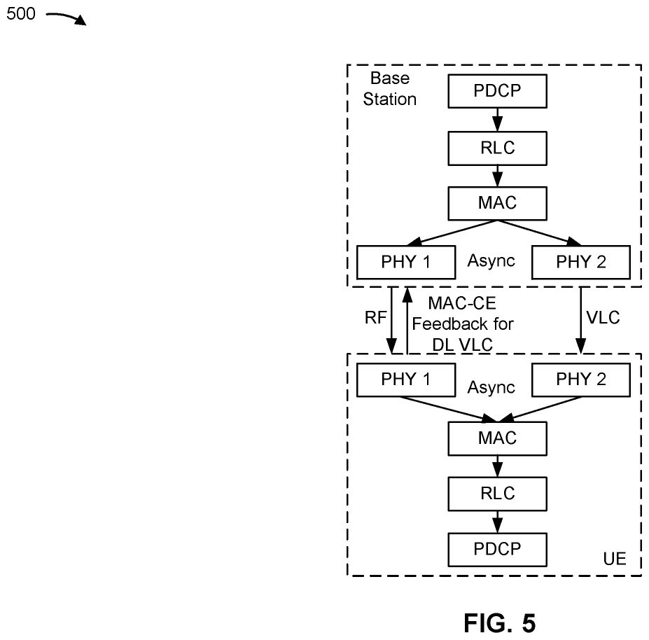

FIG. 5 is a diagram illustrating an example 500 associated with feedback for VLC transmissions, in accordance with the present disclosure.

In some aspects, a base station may be associated with a packet data convergence control (PDCP) layer, an RLC layer, a MAC layer, a first physical (PHY) layer, and a second PHY layer. A UE may be associated with a PDCP layer, an RLC layer, a MAC layer, a first PHY layer, and a second PHY layer.

In some aspects, the base station may transmit a downlink VLC transmission to the UE. The base station may transmit the downlink VLC transmission via the second PHY layer of the base station, and the UE may receive the downlink VLC transmission via the second PHY layer of the UE. The second PHY layer of the base station and the second PHY layer of the UE may be associated with downlink VLC transmissions, and the first PHY layer of the base station and the first PHY layer of the UE may be associated with uplink and/or downlink NR transmissions, where the downlink VLC transmissions may not be clock or frame synchronized with the NR transmissions. In other words, VLC transmissions may be asynchronous with the NR transmissions.

In some aspects, the UE may transmit a MAC-CE ACK/NACK feedback based at least in part on the downlink VLC transmission. A MAC-CE may be used to convey ACK/NACK feedback when the VLC transmissions are not clock or frame synchronized with the NR transmissions. The UE may transmit the MAC-CE ACK/NACK feedback rather than transmitting an L1 ACK/NACK feedback for VLC. The UE may transmit the MAC-CE ACK/NACK feedback via the first PHY layer of the UE. Further, the base station may transmit downlink RF transmissions via the first PHY layer of the base station, and the UE may receive the downlink RF transmissions from the base station via the first PHY layer of the UE.

In some aspects, a VLC HARQ ACK/NACK MAC-CE may be designed depending on whether the UE is configured with SPS VLC transmissions or dynamic scheduled VLC transmissions. When the UE is configured with the SPS VLC transmissions, the VLC HARQ ACK/NACK MAC-CE may be configured in an SPS configuration IE. When the UE is configured with the dynamically scheduled VLC transmissions (e.g., a VLC transmission is dynamically scheduled by the UE), the VLC HARQ ACK/NACK MAC-CE may be triggered by a MAC Tx entity at the base station.

As indicated above, FIG. 5 is provided as an example. Other examples may differ from what is described with regard to FIG. 5.

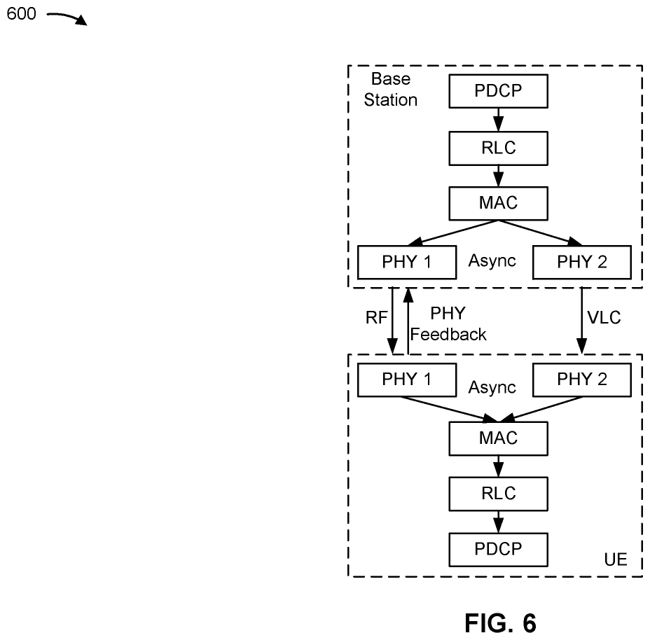

FIG. 6 is a diagram illustrating an example 600 associated with feedback for VLC transmissions, in accordance with the present disclosure.

In some aspects, a base station may transmit a downlink VLC transmission to a UE. The base station may transmit the downlink VLC transmission via a second PHY layer of the base station, and the UE may receive the downlink VLC transmission via a second PHY layer of the UE. The second PHY layer of the base station and the second PHY layer of the UE may be associated with downlink VLC transmissions, and a first PHY layer of the base station and a first PHY layer of the UE may be associated with uplink and/or downlink NR transmissions, where the downlink VLC transmissions may not be clock or frame synchronized (e.g., asynchronous) with the NR transmissions.

In some aspects, the base station may transmit a downlink RF transmission via the first PHY layer of the base station, and the UE may receive the downlink RF transmission from the base station via the first PHY layer of the UE.

In some aspects, in an NR-VLC carrier aggregation, the UE may transmit L1 ACK/NACK feedback via the first PHY layer of the UE, and the base station may receive the L1 ACK/NACK feedback via the first PHY layer of the base station. The L1 ACK/NACK feedback may be for each HARQ process, including RF transmissions and downlink VLC transmissions. In other words, the L1 ACK/NACK feedback may be a bundled feedback for both the downlink VLC transmission and the downlink RF transmission. The UE may transmit the L1 ACK/NACK feedback via an uplink RF transmission to the base station. The RF transmissions and the downlink VLC transmissions may use a same MAC entity.

In some aspects, dedicated HARQ-ACK codebooks for bundled NR and VLC feedback may support a higher reliability for the downlink VLC transmission. The dedicated HARQ-ACK codebooks may differ from a legacy NR HARQ-ACK codebook, based at least in part on a different frame structure and a different frame/slot length for VLC transmissions as compared to NR transmissions, which requires an asynchronized signaling design.

As indicated above, FIG. 6 is provided as an example. Other examples may differ from what is described with regard to FIG. 5.

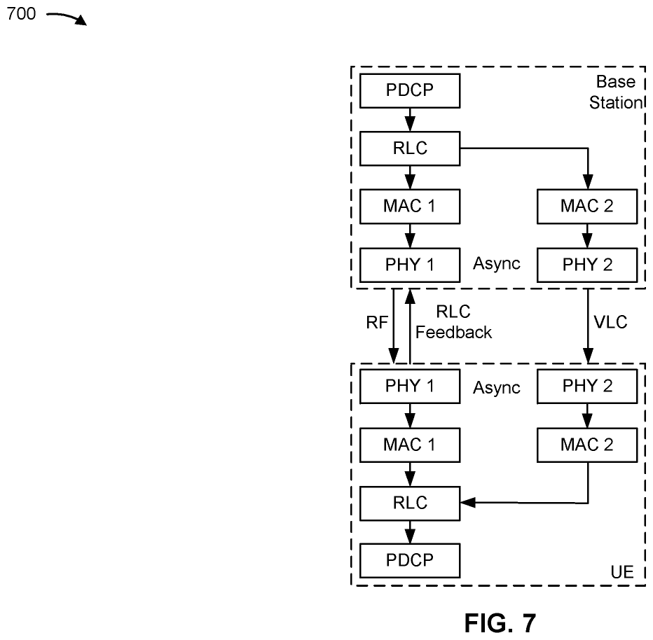

FIG. 7 is a diagram illustrating an example 700 associated with feedback for VLC transmissions, in accordance with the present disclosure.

In some aspects, a base station may be associated with a PDCP layer, an RLC layer, a first MAC layer, a second MAC layer, a first PHY layer, and a second PHY layer. A UE may be associated with a PDCP layer, an RLC layer, a first MAC layer, a second MAC layer, a first PHY layer, and a second PHY layer.

In some aspects, a base station may transmit a downlink VLC transmission to a UE. The base station may transmit the downlink VLC transmission via a second PHY layer of the base station, and the UE may receive the downlink VLC transmission via a second PHY layer of the UE. The second PHY layer of the base station and the second PHY layer of the UE may be associated with downlink VLC transmissions, and a first PHY layer of the base station and a first PHY layer of the UE may be associated with uplink and/or downlink NR transmissions, where the downlink VLC transmissions may not be clock or frame synchronized (e.g., asynchronous) with the NR transmissions.

In some aspects, the base station may transmit a downlink RF transmission via the first PHY layer of the base station, and the UE may receive the downlink RF transmission from the base station via the first PHY layer of the UE.

In some aspects, in an NR-VLC dual connectivity configuration, the UE may transmit RLC ACK/NACK feedback via the first PHY layer of the UE, and the base station may receive the RLC ACK/NACK feedback via the first PHY layer of the base station. The ACK/NACK feedback may be for each RLC PDU, including the downlink RF transmission and the downlink VLC transmission. The ACK/NACK feedback may be a bundled feedback for both the downlink VLC transmission and the downlink RF transmission. The UE may transmit the ACK/NACK feedback in an RLC status PDU via an uplink RF transmission to the base station. In other words, the UE may transmit the ACK/NACK feedback as RLC feedback. The downlink RF transmission and the downlink VLC transmission may use a same RLC entity. An RLC status PDU feedback based at least in part on VLC may be supported by RLC layers of the base station and the UE.

In some aspects, the base station may include an X2 interface between the RLC layer of the base station (e.g., an RF RLC entity) and the second MAC layer of the base station (e.g., a VLC MAC entity), which is different from a legacy NR dual connectivity configuration that includes an X2 interface between a PDCP entity in a first path and an RLC entity in a second path.

In some aspects, the RLC layer of the UE may include an RLC receiving entity and an RLC transmitting entity. The RLC receiving entity may receive data from the first MAC layer of the UE (e.g., an RF MAC entity) and the second MAC layer of the UE (e.g., a VLC MAC entity). The RLC receiving entity may generate the RLC status PDU for both an RF path associated with the downlink RF transmission and a VLC path associated with the downlink VLC transmission. The RLC receiving entity may send the RLC status PDU to the RLC transmitting entity through the RF path. The RLC transmitting entity may receive the RLC status PDU from the RLC receiving entity. The RLC transmitting entity may conduct a layer 2 (L2) retransmission based at least in part on the RLC status PDU for improved reliability. As a result, an NR-VLC dual connectivity protocol stack may support higher reliability of the downlink VLC transmission based at least in part on RLC ACK/NACK feedback.

As indicated above, FIG. 7 is provided as an example. Other examples may differ from what is described with regard to FIG. 7.

FIG. 8 is a diagram illustrating an example process 800 performed, for example, by a UE, in accordance with the present disclosure. Example process 800 is an example where the UE (e.g., UE 120) performs operations associated with feedback for VLC transmissions.

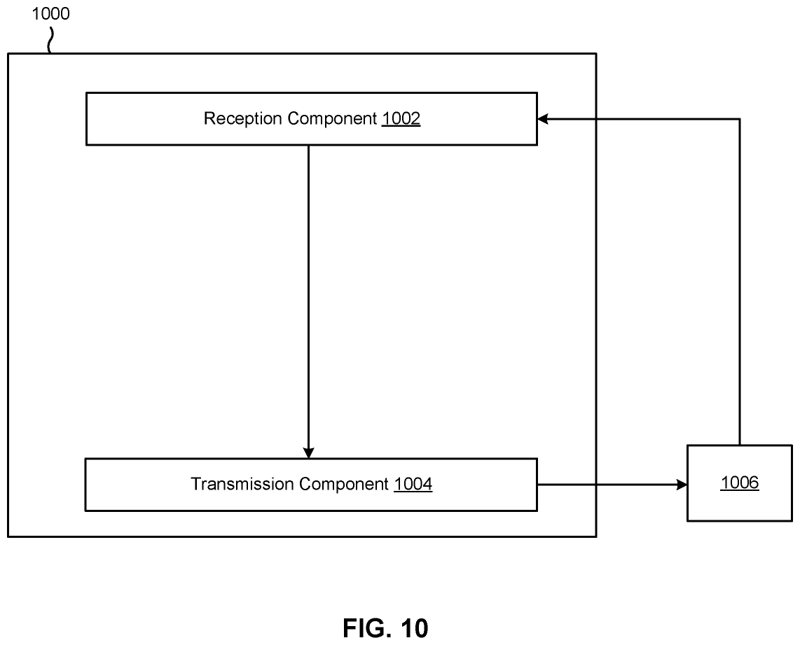

As shown in FIG. 8, in some aspects, process 800 may include receiving, from a base station, a downlink VLC transmission (block 810). For example, the UE (e.g., using reception component 1002, depicted in FIG. 10) may receive, from a base station, a downlink VLC transmission, as described above.

As further shown in FIG. 8, in some aspects, process 800 may include receiving, from the base station, a downlink NR RFC transmission, wherein a frame structure associated with the downlink VLC transmission is asynchronous with a frame structure associated with the downlink NR RFC transmission (block 820). For example, the UE (e.g., using reception component 1002, depicted in FIG. 10) may receive, from the base station, a downlink NR RFC transmission, wherein a frame structure associated with the downlink VLC transmission is asynchronous with a frame structure associated with the downlink NR RFC transmission, as described above.

As further shown in FIG. 8, in some aspects, process 800 may include transmitting, to the base station via an uplink RF transmission based at least in part on a lack of support for an uplink VLC transmission at the UE, ACK/NACK feedback associated with one or more of the downlink VLC transmission or the downlink NR RFC transmission (block 830). For example, the UE (e.g., using transmission component 1004, depicted in FIG. 10) may transmit, to the base station via an uplink RF transmission based at least in part on a lack of support for an uplink VLC transmission at the UE, ACK/NACK feedback associated with one or more of the downlink VLC transmission or the downlink NR RFC transmission, as described above.

Process 800 may include additional aspects, such as any single aspect or any combination of aspects described below and/or in connection with one or more other processes described elsewhere herein.

In a first aspect, process 800 includes transmitting, to the base station, a UE capability report that includes a first parameter and a second parameter, wherein the first parameter indicates that the UE supports the downlink VLC transmission and the second parameter indicates that the UE does not support the uplink VLC transmission.

In a second aspect, alone or in combination with the first aspect, process 800 includes transmitting a MAC-CE that indicates the ACK/NACK feedback for the downlink VLC transmission and not for the downlink NR RFC transmission, and the MAC-CE is configured in an SPS configuration IE based at least in part on the UE being configured with an SPS downlink VLC transmission, or the MAC-CE is triggered by a MAC transmit entity at the base station based at least in part on the downlink VLC transmission being dynamically scheduled for the UE.

In a third aspect, alone or in combination with one or more of the first and second aspects, process 800 includes transmitting, to the base station, a UE capability report that indicates a maximum supported quantity of HARQ processes, wherein the UE capability report indicates a maximum quantity of HARQ processes for both downlink NR RFC transmissions and downlink VLC transmissions, the UE capability report indicates a first quantity indicating a maximum quantity of HARQ processes for downlink NR RFC transmissions and a second quantity indicating a maximum quantity of HARQ processes for downlink VLC transmissions, the UE capability report indicates a first quantity indicating a maximum quantity of HARQ processes for both downlink NR RFC transmissions and downlink VLC transmissions, and a second quantity indicating a maximum quantity of HARQ processes for downlink VLC transmissions, or the UE capability report indicates a first quantity indicating a maximum quantity of HARQ processes for both downlink NR RFC transmissions and downlink VLC transmissions, and a second quantity indicating a maximum quantity of HARQ processes for downlink NR RFC transmissions.

In a fourth aspect, alone or in combination with one or more of the first through third aspects, process 800 includes transmitting, for a HARQ process, the ACK/NACK feedback that bundles feedback for both the downlink VLC transmission and the downlink NR RFC transmission, and the downlink NR RFC transmission and the downlink VLC transmission are associated with a same MAC entity of the UE.

In a fifth aspect, alone or in combination with one or more of the first through fourth aspects, the ACK/NACK feedback is associated with a first HARQ-ACK codebook for the downlink VLC transmission and a second HARQ-ACK codebook for the downlink NR RFC transmission, the ACK/NACK feedback is associated with a single HARQ-ACK codebook for both the downlink VLC transmission and the downlink NR RFC transmission, or the ACK/NACK feedback is associated with a single HARQ-ACK codebook for both the downlink VLC transmission and the downlink NR RFC transmission, wherein a DAI that is indexed based at least in part on a slot beginning boundary is separately indexed for the downlink VLC transmission and the downlink NR RFC transmission.

In a sixth aspect, alone or in combination with one or more of the first through fifth aspects, a HARQ-ACK codebook type is separately configured for the downlink VLC transmission and the downlink NR RFC transmission based at least in part on the ACK/NACK feedback being the ACK/NACK feedback, and two separate HARQ-ACK codebooks are fed back via the uplink RF transmission and include a dynamic codebook for the downlink NR RFC transmission and a semi-static codebook for the downlink VLC transmission, a dynamic codebook for the downlink NR RFC transmission and a dynamic codebook for the downlink VLC transmission, a semi-static codebook for the downlink NR RFC transmission and a semi-static codebook for the downlink VLC transmission, or a semi-static codebook for the downlink NR RFC transmission and a dynamic codebook for the downlink VLC transmission.

In a seventh aspect, alone or in combination with one or more of the first through sixth aspects, process 800 includes transmitting, for each RLC PDU, the ACK/NACK feedback in an RLC status PDU that bundles feedback for both the downlink VLC transmission and the downlink NR RFC transmission, wherein the RLC status PDU is based at least in part on data received from an RF MAC entity of the UE and a VLC MAC entity of the UE, and the downlink NR RFC transmission and the downlink VLC transmission are associated with a same RLC entity of the UE.

In an eighth aspect, alone or in combination with one or more of the first through seventh aspects, the UE is configured for an NR-VLC carrier aggregation or an NR-VLC dual connectivity.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a base station, in accordance with the present disclosure. Example process 900 is an example where the base station (e.g., base station 110) performs operations associated with feedback for VLC transmissions.

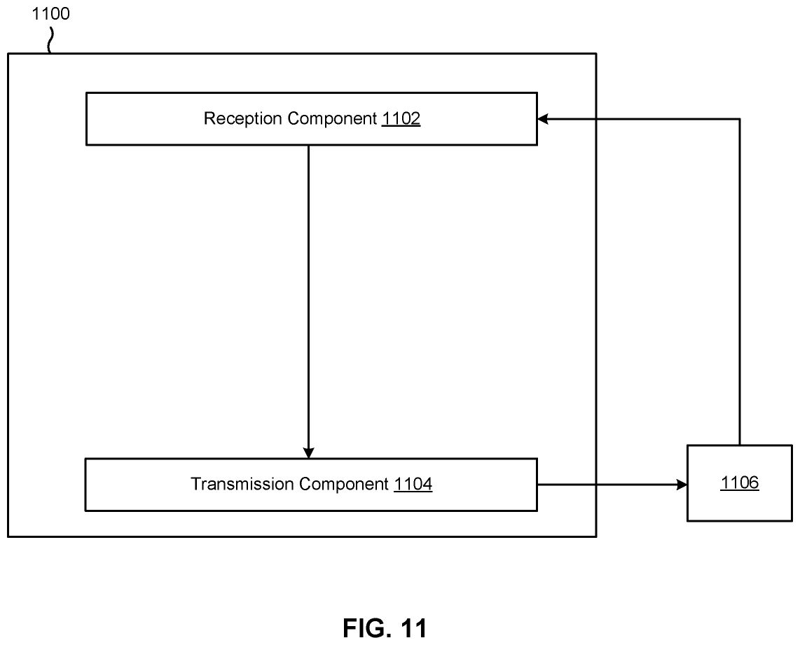

As shown in FIG. 9, in some aspects, process 900 may include transmitting, to a UE, a downlink VLC transmission (block 910). For example, the base station (e.g., using transmission component 1104, depicted in FIG. 11) may transmit, to a UE, a downlink VLC transmission, as described above.

As further shown in FIG. 9, in some aspects, process 900 may include transmitting, to the UE, a downlink NR RFC transmission, wherein a frame structure associated with the downlink VLC transmission is asynchronous with a frame structure associated with the downlink NR RFC transmission (block 920). For example, the base station (e.g., using transmission component 1104, depicted in FIG. 11) may transmit, to the UE, a downlink NR RFC transmission, wherein a frame structure associated with the downlink VLC transmission is asynchronous with a frame structure associated with the downlink NR RFC transmission, as described above.

As further shown in FIG. 9, in some aspects, process 900 may include receiving, from the UE via an uplink RF transmission based at least in part on a lack of support for an uplink VLC transmission at the UE, ACK/NACK feedback associated with one or more of the downlink VLC transmission or the downlink NR RFC transmission (block 930). For example, the base station (e.g., using reception component 1102, depicted in FIG. 11) may receive, from the UE via an uplink RF transmission based at least in part on a lack of support for an uplink VLC transmission at the UE, ACK/NACK feedback associated with one or more of the downlink VLC transmission or the downlink NR RFC transmission, as described above.

Process 900 may include additional aspects, such as any single aspect or any combination of aspects described below and/or in connection with one or more other processes described elsewhere herein.

In a first aspect, process 900 includes receiving, from the UE, a UE capability report that includes a first parameter and a second parameter, wherein the first parameter indicates that the UE supports the downlink VLC transmission and the second parameter indicates that the UE does not support the uplink VLC transmission.

In a second aspect, alone or in combination with the first aspect, process 900 includes receiving a MAC-CE that indicates the ACK/NACK feedback for the downlink VLC transmission and not for the downlink NR RFC transmission, and the MAC-CE is configured in an SPS configuration IE based at least in part on the UE being configured with an SPS downlink VLC transmission, or the MAC-CE is triggered by a MAC transmit entity at the base station based at least in part on the downlink VLC transmission being dynamically scheduled for the UE.

In a third aspect, alone or in combination with one or more of the first and second aspects, process 900 includes receiving, from the UE, a UE capability report that indicates a maximum supported quantity of HARQ processes, wherein the UE capability report indicates a maximum quantity of HARQ processes for both downlink NR RFC transmissions and downlink VLC transmissions, the UE capability report indicates a first quantity indicating a maximum quantity of HARQ processes for downlink NR RFC transmissions and a second quantity indicating a maximum quantity of HARQ processes for downlink VLC transmissions, the UE capability report indicates a first quantity indicating a maximum quantity of HARQ processes for both downlink NR RFC transmissions and downlink VLC transmissions, and a second quantity indicating a maximum quantity of HARQ processes for downlink VLC transmissions, or the UE capability report indicates a first quantity indicating a maximum quantity of HARQ processes for both downlink NR RFC transmissions and downlink VLC transmissions, and a second quantity indicating a maximum quantity of HARQ processes for downlink NR RFC transmissions.

In a fourth aspect, alone or in combination with one or more of the first through third aspects, process 900 includes receiving, for a HARQ process, the ACK/NACK feedback that bundles feedback for both the downlink VLC transmission and the downlink NR RFC transmission.

In a fifth aspect, alone or in combination with one or more of the first through fourth aspects, process 900 includes receiving, for each RLC PDU, the ACK/NACK feedback in an RLC status PDU that bundles feedback for both the downlink VLC transmission and the downlink NR RFC transmission.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication. The apparatus 1000 may be a UE, or a UE may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004.

In some aspects, the apparatus 1000 may be configured to perform one or more operations described herein in connection with FIGS. 4-7. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the UE described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the UE described in connection with FIG. 2. In some aspects, the transmission component 1004 may be co-located with the reception component 1002 in a transceiver.

The reception component 1002 may receive, from a base station, a downlink VLC transmission. The reception component 1002 may receive, from the base station, a downlink NR RFC transmission, wherein a frame structure associated with the downlink VLC transmission is asynchronous with a frame structure associated with the downlink NR RFC transmission. The transmission component 1004 may transmit, to the base station via an uplink RF transmission based at least in part on a lack of support for an uplink VLC transmission at the UE, ACK/NACK feedback associated with one or more of the downlink VLC transmission or the downlink NR RFC transmission. The transmission component 1004 may transmit, to the base station, a UE capability report that includes a first parameter and a second parameter, wherein the first parameter indicates that the UE supports the downlink VLC transmission and the second parameter indicates that the UE does not support the uplink VLC transmission.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication. The apparatus 1100 may be a base station, or a base station may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104.

In some aspects, the apparatus 1100 may be configured to perform one or more operations described herein in connection with FIGS. 4-7. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the base station described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the base station described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the base station described in connection with FIG. 2. In some aspects, the transmission component 1104 may be co-located with the reception component 1102 in a transceiver.

The transmission component 1104 may transmit, to a UE, a downlink VLC transmission. The transmission component 1104 may transmit, to the UE, a downlink NR RFC transmission, wherein a frame structure associated with the downlink VLC transmission is asynchronous with a frame structure associated with the downlink NR RFC transmission. The reception component 1102 may receive, from the UE via an uplink RF transmission based at least in part on a lack of support for an uplink VLC transmission at the UE, ACK/NACK feedback associated with one or more of the downlink VLC transmission or the downlink NR RFC transmission. The reception component 1102 may receive, from the UE, a UE capability report that includes a first parameter and a second parameter, wherein the first parameter indicates that the UE supports the downlink VLC transmission and the second parameter indicates that the UE does not support the uplink VLC transmission.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:
Aspect 1: A method of wireless communication performed by a user equipment (UE), comprising: receiving, from a base station, a downlink visible light communication (VLC) transmission; receiving, from the base station, a downlink NR RF-based communication (RFC) transmission, wherein a frame structure associated with the downlink VLC transmission is asynchronous with a frame structure associated with the downlink NR RFC transmission; and transmitting, to the base station via an uplink RF transmission based at least in part on a lack of support for an uplink VLC transmission at the UE, acknowledgement or negative acknowledgement (ACK/NACK) feedback associated with one or more of the downlink VLC transmission or the downlink NR RFC transmission.
Aspect 2: The method of Aspect 1, further comprising: transmitting, to the base station, a UE capability report that includes a first parameter and a second parameter, wherein the first parameter indicates that the UE supports the downlink VLC transmission and the second parameter indicates that the UE does not support the uplink VLC transmission.
Aspect 3: The method of any of Aspects 1 through 2, wherein transmitting the ACK/NACK feedback comprises transmitting a medium access control control element (MAC-CE) that indicates the ACK/NACK feedback for the downlink VLC transmission and not for the downlink NR RFC transmission, and wherein: the MAC-CE is configured in a semi-persistent scheduling (SPS) configuration information element based at least in part on the UE being configured with an SPS downlink VLC transmission, or the MAC-CE is triggered by a medium access control (MAC) transmit entity at the base station based at least in part on the downlink VLC transmission being dynamically scheduled for the UE.
Aspect 4: The method of any of Aspects 1 through 3, further comprising: transmitting, to the base station, a UE capability report that indicates a maximum supported quantity of hybrid automatic repeat request (HARQ) processes, wherein: the UE capability report indicates a maximum quantity of HARQ processes for both downlink NR RFC transmissions and downlink VLC transmissions; the UE capability report indicates a first quantity indicating a maximum quantity of HARQ processes for downlink NR RFC transmissions and a second quantity indicating a maximum quantity of HARQ processes for downlink VLC transmissions; the UE capability report indicates a first quantity indicating a maximum quantity of HARQ processes for both downlink NR RFC transmissions and downlink VLC transmissions, and a second quantity indicating a maximum quantity of HARQ processes for downlink VLC transmissions; or the UE capability report indicates a first quantity indicating a maximum quantity of HARQ processes for both downlink NR RFC transmissions and downlink VLC transmissions, and a second quantity indicating a maximum quantity of HARQ processes for downlink NR RFC transmissions.
Aspect 5: The method of any of Aspects 1 through 4, wherein transmitting the ACK/NACK feedback comprises transmitting, for a hybrid automatic repeat request (HARQ) process, the ACK/NACK feedback that bundles feedback for both the downlink VLC transmission and the downlink NR RFC transmission, and wherein the downlink NR RFC transmission and the downlink VLC transmission are associated with a same medium access control (MAC) entity of the UE.
Aspect 6: The method of any of Aspects 1 through 5, wherein: the ACK/NACK feedback is associated with a first hybrid automatic repeat request (HARQ)-ACK codebook for the downlink VLC transmission and a second HARQ-ACK codebook for the downlink NR RFC transmission; the ACK/NACK feedback is associated with a single HARQ-ACK codebook for both the downlink VLC transmission and the downlink NR RFC transmission; or the ACK/NACK feedback is associated with a single HARQ-ACK codebook for both the downlink VLC transmission and the downlink NR RFC transmission, wherein a downlink assignment indicator that is indexed based at least in part on a slot beginning boundary is separately indexed for the downlink VLC transmission and the downlink NR RFC transmission.
Aspect 7: The method of any of Aspects 1 through 6, wherein a hybrid automatic repeat request (HARQ)-ACK codebook type is separately configured for the downlink VLC transmission and the downlink NR RFC transmission based at least in part on the ACK/NACK feedback being a layer 1 ACK/NACK feedback, and wherein two separate HARQ-ACK codebooks are fed back via the uplink RF transmission and include: a dynamic codebook for the downlink NR RFC transmission and a semi-static codebook for the downlink VLC transmission; a dynamic codebook for the downlink NR RFC transmission and a dynamic codebook for the downlink VLC transmission; a semi-static codebook for the downlink NR RFC transmission and a semi-static codebook for the downlink VLC transmission; or a semi-static codebook for the downlink NR RFC transmission and a dynamic codebook for the downlink VLC transmission.
Aspect 8: The method of any of Aspects 1 through 7, wherein transmitting the ACK/NACK feedback comprises transmitting, for each radio link control (RLC) protocol data unit (PDU), the ACK/NACK feedback in an RLC status PDU that bundles feedback for both the downlink VLC transmission and the downlink NR RFC transmission, wherein the RLC status PDU is based at least in part on data received from an RF medium access control (MAC) entity of the UE and a VLC MAC entity of the UE, and wherein the downlink NR RFC transmission and the downlink VLC transmission are associated with a same RLC entity of the UE.
Aspect 9: The method of any of Aspects 1 through 8, wherein the UE is configured for an NR-VLC carrier aggregation or an NR-VLC dual connectivity.
Aspect 10: A method of wireless communication performed by a base station, comprising: transmitting, to a user equipment (UE), a downlink visible light communication (VLC) transmission; transmitting, to the UE, a downlink NR RF-based communication (RFC) transmission, wherein a frame structure associated with the downlink VLC transmission is asynchronous with a frame structure associated with the downlink NR RFC transmission; and receiving, from the UE via an uplink RF transmission based at least in part on a lack of support for an uplink VLC transmission at the UE, acknowledgement or negative acknowledgement (ACK/NACK) feedback associated with one or more of the downlink VLC transmission or the downlink NR RFC transmission.
Aspect 11: The method of Aspect 10, further comprising: receiving, from the UE, a UE capability report that includes a first parameter and a second parameter, wherein the first parameter indicates that the UE supports the downlink VLC transmission and the second parameter indicates that the UE does not support the uplink VLC transmission.
Aspect 12: The method of any of Aspects 10 through 11, wherein receiving the ACK/NACK feedback comprises receiving a medium access control control element (MAC-CE) that indicates the ACK/NACK feedback for the downlink VLC transmission and not for the downlink NR RFC transmission, and wherein: the MAC-CE is configured in a semi-persistent scheduling (SPS) configuration information element based at least in part on the UE being configured with an SPS downlink VLC transmission, or the MAC-CE is triggered by a medium access control (MAC) transmit entity at the base station based at least in part on the downlink VLC transmission being dynamically scheduled for the UE.
Aspect 13: The method of any of Aspects 10 through 12, further comprising: receiving, from the UE, a UE capability report that indicates a maximum supported quantity of hybrid automatic repeat request (HARQ) processes, wherein: the UE capability report indicates a maximum quantity of HARQ processes for both downlink NR RFC transmissions and downlink VLC transmissions; the UE capability report indicates a first quantity indicating a maximum quantity of HARQ processes for downlink NR RFC transmissions and a second quantity indicating a maximum quantity of HARQ processes for downlink VLC transmissions; the UE capability report indicates a first quantity indicating a maximum quantity of HARQ processes for both downlink NR RFC transmissions and downlink VLC transmissions, and a second quantity indicating a maximum quantity of HARQ processes for downlink VLC transmissions; or the UE capability report indicates a first quantity indicating a maximum quantity of HARQ processes for both downlink NR RFC transmissions and downlink VLC transmissions, and a second quantity indicating a maximum quantity of HARQ processes for downlink NR RFC transmissions.
Aspect 14: The method of any of Aspects 10 through 13, wherein receiving the ACK/NACK feedback comprises receiving, for a hybrid automatic repeat request (HARQ) process, the ACK/NACK feedback that bundles feedback for both the downlink VLC transmission and the downlink NR RFC transmission.
Aspect 15: The method of any of Aspects 10 through 14, wherein: the ACK/NACK feedback is associated with a first hybrid automatic repeat request (HARQ)-ACK codebook for the downlink VLC transmission and a second HARQ-ACK codebook for the downlink NR RFC transmission; the ACK/NACK feedback is associated with a single HARQ-ACK codebook for both the downlink VLC transmission and the downlink NR RFC transmission; or the ACK/NACK feedback is associated with a single HARQ-ACK codebook for both the downlink VLC transmission and the downlink NR RFC transmission, wherein a downlink assignment indicator that is indexed based at least in part on a slot beginning boundary is separately indexed for the downlink VLC transmission and the downlink NR RFC transmission.
Aspect 16: The method of any of Aspects 10 through 15, wherein a hybrid automatic repeat request (HARQ)-ACK codebook type is separately configured for the downlink VLC transmission and the downlink NR RFC transmission based at least in part on the ACK/NACK feedback being a layer 1 ACK/NACK feedback, and wherein two separate HARQ-ACK codebooks are fed back via the uplink RF transmission and include: a dynamic codebook for the downlink NR RFC transmission and a semi-static codebook for the downlink VLC transmission; a dynamic codebook for the downlink NR RFC transmission and a dynamic codebook for the downlink VLC transmission; a semi-static codebook for the downlink NR RFC transmission and a semi-static codebook for the downlink VLC transmission; or a semi-static codebook for the downlink NR RFC transmission and a dynamic codebook for the downlink VLC transmission.
Aspect 17: The method of any of Aspects 10 through 16, wherein receiving the ACK/NACK feedback comprises receiving, for each radio link control (RLC) protocol data unit (PDU), the ACK/NACK feedback in an RLC status PDU that bundles feedback for both the downlink VLC transmission and the downlink NR RFC transmission.
Aspect 18: An apparatus for wireless communication at a device, comprising a processor; memory coupled with the processor; and instructions stored in the memory and executable by the processor to cause the apparatus to perform the method of one or more of Aspects 1-9.
Aspect 19: A device for wireless communication, comprising a memory and one or more processors coupled to the memory, the one or more processors configured to perform the method of one or more of Aspects 1-9.
Aspect 20: An apparatus for wireless communication, comprising at least one means for performing the method of one or more of Aspects 1-9.
Aspect 21: A non-transitory computer-readable medium storing code for wireless communication, the code comprising instructions executable by a processor to perform the method of one or more of Aspects 1-9.
Aspect 22: A non-transitory computer-readable medium storing a set of instructions for wireless communication, the set of instructions comprising one or more instructions that, when executed by one or more processors of a device, cause the device to perform the method of one or more of Aspects 1-9.
Aspect 23: An apparatus for wireless communication at a device, comprising a processor; memory coupled with the processor; and instructions stored in the memory and executable by the processor to cause the apparatus to perform the method of one or more of Aspects 10-17.
Aspect 24: A device for wireless communication, comprising a memory and one or more processors coupled to the memory, the one or more processors configured to perform the method of one or more of Aspects 10-17.
Aspect 25: An apparatus for wireless communication, comprising at least one means for performing the method of one or more of Aspects 10-17.
Aspect 26: A non-transitory computer-readable medium storing code for wireless communication, the code comprising instructions executable by a processor to perform the method of one or more of Aspects 10-17.
Aspect 27: A non-transitory computer-readable medium storing a set of instructions for wireless communication, the set of instructions comprising one or more instructions that, when executed by one or more processors of a device, cause the device to perform the method of one or more of Aspects 10-17.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of”' a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
a photo detector or an image sensor;
a transceiver;
a memory; and
one or more processors, coupled to the memory, configured to:
receive, from a base station via the photo detector or the image sensor, a downlink visible light communication (VLC) transmission;
receive, from the base station via the transceiver, a downlink New Radio (NR) radio frequency (RF)-based communication (RFC) transmission, wherein a frame structure associated with the downlink VLC transmission is asynchronous with a frame structure associated with the downlink NR RFC transmission; and
transmit, to the base station via the transceiver and via an uplink RF transmission based at least in part on a lack of support for an uplink VLC transmission at the UE, acknowledgement or negative acknowledgement (ACK/NACK) feedback associated with one or more of the downlink VLC transmission or the downlink NR RFC transmission.

2. The apparatus of claim 1, wherein the one or more processors are further configured to:
transmit, to the base station via the transceiver, a UE capability report that includes a first parameter and a second parameter, wherein the first parameter indicates that the UE supports the downlink VLC transmission and the second parameter indicates that the UE does not support the uplink VLC transmission.

3. The apparatus of claim 1, wherein the one or more processors, to transmit the ACK/NACK feedback, are configured to transmit a medium access control control element (MAC-CE) that indicates the ACK/NACK feedback for the downlink VLC transmission and not for the downlink NR RFC transmission, and wherein:
the MAC-CE is configured in a semi-persistent scheduling (SPS) configuration information element based at least in part on the UE being configured with an SPS downlink VLC transmission, or
the MAC-CE is triggered by a medium access control (MAC) transmit entity at the base station based at least in part on the downlink VLC transmission being dynamically scheduled for the UE.

4. The apparatus of claim 1, wherein the one or more processors are further configured to:
transmit, to the base station via the transceiver, a UE capability report that indicates a maximum supported quantity of hybrid automatic repeat request (HARQ) processes, wherein:
the UE capability report indicates a maximum quantity of HARQ processes for both downlink NR RFC transmissions and downlink VLC transmissions;
the UE capability report indicates a first quantity indicating a maximum quantity of HARQ processes for downlink NR RFC transmissions and a second quantity indicating a maximum quantity of HARQ processes for downlink VLC transmissions;
the UE capability report indicates a first quantity indicating a maximum quantity of HARQ processes for both downlink NR RFC transmissions and downlink VLC transmissions, and a second quantity indicating a maximum quantity of HARQ processes for downlink VLC transmissions; or
the UE capability report indicates a first quantity indicating a maximum quantity of HARQ processes for both downlink NR RFC transmissions and downlink VLC transmissions, and a second quantity indicating a maximum quantity of HARQ processes for downlink NR RFC transmissions.

5. The apparatus of claim 1, wherein the one or more processors, to transmit the ACK/NACK feedback, are configured to transmit, for a hybrid automatic repeat request (HARQ) process, the ACK/NACK feedback that bundles feedback for both the downlink VLC transmission and the downlink NR RFC transmission, and wherein the downlink NR RFC transmission and the downlink VLC transmission are associated with a same medium access control (MAC) entity of the UE.

6. The apparatus of claim 1, wherein:
the ACK/NACK feedback is associated with a first hybrid automatic repeat request (HARQ)-ACK codebook for the downlink VLC transmission and a second HARQ-ACK codebook for the downlink NR RFC transmission;
the ACK/NACK feedback is associated with a single HARQ-ACK codebook for both the downlink VLC transmission and the downlink NR RFC transmission; or
the ACK/NACK feedback is associated with a single HARQ-ACK codebook for both the downlink VLC transmission and the downlink NR RFC transmission, wherein a downlink assignment indicator that is indexed based at least in part on a slot beginning boundary is separately indexed for the downlink VLC transmission and the downlink NR RFC transmission.

7. The apparatus of claim 1, wherein a hybrid automatic repeat request (HARQ)-ACK codebook type is separately configured for the downlink VLC transmission and the downlink NR RFC transmission based at least in part on the ACK/NACK feedback being a layer 1 ACK/NACK feedback, and wherein two separate HARQ-ACK codebooks are fed back via the uplink RF transmission and include:
a dynamic codebook for the downlink NR RFC transmission and a semi-static codebook for the downlink VLC transmission;
a dynamic codebook for the downlink NR RFC transmission and a dynamic codebook for the downlink VLC transmission;
a semi-static codebook for the downlink NR RFC transmission and a semi-static codebook for the downlink VLC transmission; or
a semi-static codebook for the downlink NR RFC transmission and a dynamic codebook for the downlink VLC transmission.

8. The apparatus of claim 1, wherein the one or more processors, to transmit the ACK/NACK feedback, are configured to transmit, for each radio link control (RLC) protocol data unit (PDU), the ACK/NACK feedback in an RLC status PDU that bundles feedback for both the downlink VLC transmission and the downlink NR RFC transmission, wherein the RLC status PDU is based at least in part on data received from an RF medium access control (MAC) entity of the UE and a VLC MAC entity of the UE, and wherein the downlink NR RFC transmission and the downlink VLC transmission are associated with a same RLC entity of the UE.

9. The apparatus of claim 1, wherein the UE is configured for an NR-VLC carrier aggregation or an NR-VLC dual connectivity.

10. An apparatus for wireless communication at a base station, comprising:
a light emitting diode or a laser diode;
a transceiver;
a memory; and
one or more processors, coupled to the memory, configured to:
transmit, to a user equipment (UE) via the light emitting diode or the laser diode, a downlink visible light communication (VLC) transmission;
transmit, to the UE via the transceiver, a downlink New Radio (NR) radio frequency (RF)-based communication (RFC) transmission, wherein a frame structure associated with the downlink VLC transmission is asynchronous with a frame structure associated with the downlink NR RFC transmission; and
receive, from the UE via the transceiver and via an uplink RF transmission based at least in part on a lack of support for an uplink VLC transmission at the UE, acknowledgement or negative acknowledgement (ACK/NACK) feedback associated with one or more of the downlink VLC transmission or the downlink NR RFC transmission.

11. The apparatus of claim 10, wherein the one or more processors are further configured to:
receive, from the UE via the transceiver, a UE capability report that includes a first parameter and a second parameter, wherein the first parameter indicates that the UE supports the downlink VLC transmission and the second parameter indicates that the UE does not support the uplink VLC transmission.

12. The apparatus of claim 10, wherein the one or more processors, to receive the ACK/NACK feedback, are configured to receive a medium access control control element (MAC-CE) that indicates the ACK/NACK feedback for the downlink VLC transmission and not for the downlink NR RFC transmission, and wherein:
the MAC-CE is configured in a semi-persistent scheduling (SPS) configuration information element based at least in part on the UE being configured with an SPS downlink VLC transmission, or
the MAC-CE is triggered by a medium access control (MAC) transmit entity at the base station based at least in part on the downlink VLC transmission being dynamically scheduled for the UE.

13. The apparatus of claim 10, wherein the one or more processors are further configured to:
receiving, from the UE, a UE capability report that indicates a maximum supported quantity of hybrid automatic repeat request (HARQ) processes, wherein:
the UE capability report indicates a maximum quantity of HARQ processes for both downlink NR RFC transmissions and downlink VLC transmissions;
the UE capability report indicates a first quantity indicating a maximum quantity of HARQ processes for downlink NR RFC transmissions and a second quantity indicating a maximum quantity of HARQ processes for downlink VLC transmissions;
the UE capability report indicates a first quantity indicating a maximum quantity of HARQ processes for both downlink NR RFC transmissions and downlink VLC transmissions, and a second quantity indicating a maximum quantity of HARQ processes for downlink VLC transmissions; or
the UE capability report indicates a first quantity indicating a maximum quantity of HARQ processes for both downlink NR RFC transmissions and downlink VLC transmissions, and a second quantity indicating a maximum quantity of HARQ processes for downlink NR RFC transmissions.

14. The apparatus of claim 10, wherein the one or more processors, to receive the ACK/NACK feedback, are configured to receive, for a hybrid automatic repeat request (HARQ) process, the ACK/NACK feedback that bundles feedback for both the downlink VLC transmission and the downlink NR RFC transmission.

15. The apparatus of claim 10, wherein:
the ACK/NACK feedback is associated with a first hybrid automatic repeat request (HARQ)-ACK codebook for the downlink VLC transmission and a second HARQ-ACK codebook for the downlink NR RFC transmission;
the ACK/NACK feedback is associated with a single HARQ-ACK codebook for both the downlink VLC transmission and the downlink NR RFC transmission; or
the ACK/NACK feedback is associated with a single HARQ-ACK codebook for both the downlink VLC transmission and the downlink NR RFC transmission, wherein a downlink assignment indicator that is indexed based at least in part on a slot beginning boundary is separately indexed for the downlink VLC transmission and the downlink NR RFC transmission.

16. The apparatus of claim 10, wherein a hybrid automatic repeat request (HARQ)-ACK codebook type is separately configured for the downlink VLC transmission and the downlink NR RFC transmission based at least in part on the ACK/NACK feedback being a layer 1 ACK/NACK feedback, and wherein two separate HARQ-ACK codebooks are fed back via the uplink RF transmission and include:
a dynamic codebook for the downlink NR RFC transmission and a semi-static codebook for the downlink VLC transmission;
a dynamic codebook for the downlink NR RFC transmission and a dynamic codebook for the downlink VLC transmission;
a semi-static codebook for the downlink NR RFC transmission and a semi-static codebook for the downlink VLC transmission; or
a semi-static codebook for the downlink NR RFC transmission and a dynamic codebook for the downlink VLC transmission.

17. The apparatus of claim 10, wherein the one or more processors, to receive the ACK/NACK feedback, are configured to receive, for each radio link control (RLC) protocol data unit (PDU), the ACK/NACK feedback in an RLC status PDU that bundles feedback for both the downlink VLC transmission and the downlink NR RFC transmission.

18. A method of wireless communication performed by a user equipment (UE), comprising:
receiving, from a base station, a downlink visible light communication (VLC) transmission;
receiving, from the base station, a downlink New Radio (NR) radio frequency (RF)-based communication (RFC) transmission, wherein a frame structure associated with the downlink VLC transmission is asynchronous with a frame structure associated with the downlink NR RFC transmission; and
transmitting, to the base station via an uplink RF transmission based at least in part on a lack of support for an uplink VLC transmission at the UE, acknowledgement or negative acknowledgement (ACK/NACK) feedback associated with one or more of the downlink VLC transmission or the downlink NR RFC transmission.

19. The method of claim 18, wherein transmitting the ACK/NACK feedback comprises transmitting a medium access control control element (MAC-CE) that indicates the ACK/NACK feedback for the downlink VLC transmission and not for the downlink NR RFC transmission, and wherein:
the MAC-CE is configured in a semi-persistent scheduling (SPS) configuration information element based at least in part on the UE being configured with an SPS downlink VLC transmission; or
the MAC-CE is triggered by a medium access control (MAC) transmit entity at the base station based at least in part on the downlink VLC transmission being dynamically scheduled for the UE.

20. The method of claim 18, further comprising:
transmitting, to the base station, a UE capability report that indicates: a first parameter indicating that the UE supports the downlink VLC transmission, a second parameter indicating that the UE does not support the uplink VLC transmission, and a maximum supported quantity of hybrid automatic repeat request (HARQ) processes, wherein:
the UE capability report indicates a maximum quantity of HARQ processes for both downlink NR RFC transmissions and downlink VLC transmissions;
the UE capability report indicates a first quantity indicating a maximum quantity of HARQ processes for downlink NR RFC transmissions and a second quantity indicating a maximum quantity of HARQ processes for downlink VLC transmissions;
the UE capability report indicates a first quantity indicating a maximum quantity of HARQ processes for both downlink NR RFC transmissions and downlink VLC transmissions, and a second quantity indicating a maximum quantity of HARQ processes for downlink VLC transmissions; or
the UE capability report indicates a first quantity indicating a maximum quantity of HARQ processes for both downlink NR RFC transmissions and downlink VLC transmissions, and a second quantity indicating a maximum quantity of HARQ processes for downlink NR RFC transmissions.

21. The method of claim 18, wherein:
transmitting the ACK/NACK feedback comprises transmitting, for a hybrid automatic repeat request (HARQ) process, the ACK/NACK feedback that bundles feedback for both the downlink VLC transmission and the downlink NR RFC transmission, and wherein the downlink NR RFC transmission and the downlink VLC transmission are associated with a same medium access control (MAC) entity of the UE; or
transmitting the ACK/NACK feedback comprises transmitting, for each radio link control (RLC) protocol data unit (PDU), the ACK/NACK feedback in an RLC status PDU that bundles feedback for both the downlink VLC transmission and the downlink NR RFC transmission, wherein the RLC status PDU is based at least in part on data received from an RF MAC entity of the UE and a VLC MAC entity of the UE, and wherein the downlink NR RFC transmission and the downlink VLC transmission are associated with a same RLC entity of the UE.

22. The method of claim 18, wherein:
the ACK/NACK feedback is associated with a first hybrid automatic repeat request (HARQ)-ACK codebook for the downlink VLC transmission and a second HARQ-ACK codebook for the downlink NR RFC transmission;
the ACK/NACK feedback is associated with a single HARQ-ACK codebook for both the downlink VLC transmission and the downlink NR RFC transmission; or
the ACK/NACK feedback is associated with a single HARQ-ACK codebook for both the downlink VLC transmission and the downlink NR RFC transmission, wherein a downlink assignment indicator that is indexed based at least in part on a slot beginning boundary is separately indexed for the downlink VLC transmission and the downlink NR RFC transmission.

23. The method of claim 18, wherein a hybrid automatic repeat request (HARQ)-ACK codebook type is separately configured for the downlink VLC transmission and the downlink NR RFC transmission based at least in part on the ACK/NACK feedback being a layer 1 ACK/NACK feedback, and wherein two separate HARQ-ACK codebooks are fed back via the uplink RF transmission and include:
a dynamic codebook for the downlink NR RFC transmission and a semi-static codebook for the downlink VLC transmission;
a dynamic codebook for the downlink NR RFC transmission and a dynamic codebook for the downlink VLC transmission;
a semi-static codebook for the downlink NR RFC transmission and a semi-static codebook for the downlink VLC transmission; or
a semi-static codebook for the downlink NR RFC transmission and a dynamic codebook for the downlink VLC transmission.

24. The method of claim 18, wherein the UE is configured for an NR-VLC carrier aggregation or an NR-VLC dual connectivity.

25. A method of wireless communication performed by a base station, comprising:
transmitting, to a user equipment (UE), a downlink visible light communication (VLC) transmission;
transmitting, to the UE, a downlink New Radio (NR) radio frequency (RF)-based communication (RFC) transmission, wherein a frame structure associated with the downlink VLC transmission is asynchronous with a frame structure associated with the downlink NR RFC transmission; and
receiving, from the UE via an uplink RF transmission based at least in part on a lack of support for an uplink VLC transmission at the UE, acknowledgement or negative acknowledgement (ACK/NACK) feedback associated with one or more of the downlink VLC transmission or the downlink NR RFC transmission.

26. The method of claim 25, wherein receiving the ACK/NACK feedback comprises receiving a medium access control control element (MAC-CE) that indicates the ACK/NACK feedback for the downlink VLC transmission and not for the downlink NR RFC transmission, and wherein:
the MAC-CE is configured in a semi-persistent scheduling (SPS) configuration information element based at least in part on the UE being configured with an SPS downlink VLC transmission; or
the MAC-CE is triggered by a medium access control (MAC) transmit entity at the base station based at least in part on the downlink VLC transmission being dynamically scheduled for the UE.

27. The method of claim 25, further comprising:
receiving, from the UE, a UE capability report that indicates: a first parameter indicating that the UE supports the downlink VLC transmission, a second parameter indicating that the UE does not support the uplink VLC transmission, and a maximum supported quantity of hybrid automatic repeat request (HARQ) processes, wherein:
the UE capability report indicates a maximum quantity of HARQ processes for both downlink NR RFC transmissions and downlink VLC transmissions;
the UE capability report indicates a first quantity indicating a maximum quantity of HARQ processes for downlink NR RFC transmissions and a second quantity indicating a maximum quantity of HARQ processes for downlink VLC transmissions;
the UE capability report indicates a first quantity indicating a maximum quantity of HARQ processes for both downlink NR RFC transmissions and downlink VLC transmissions, and a second quantity indicating a maximum quantity of HARQ processes for downlink VLC transmissions; or
the UE capability report indicates a first quantity indicating a maximum quantity of HARQ processes for both downlink NR RFC transmissions and downlink VLC transmissions, and a second quantity indicating a maximum quantity of HARQ processes for downlink NR RFC transmissions.

28. The method of claim 25, wherein:
receiving the ACK/NACK feedback comprises receiving, for a hybrid automatic repeat request (HARQ) process, the ACK/NACK feedback that bundles feedback for both the downlink VLC transmission and the downlink NR RFC transmission; or
receiving the ACK/NACK feedback comprises receiving, for each radio link control (RLC) protocol data unit (PDU), the ACK/NACK feedback in an RLC status PDU that bundles feedback for both the downlink VLC transmission and the downlink NR RFC transmission.

29. The method of claim 25, wherein:
the ACK/NACK feedback is associated with a first hybrid automatic repeat request (HARQ)-ACK codebook for the downlink VLC transmission and a second HARQ-ACK codebook for the downlink NR RFC transmission;
the ACK/NACK feedback is associated with a single HARQ-ACK codebook for both the downlink VLC transmission and the downlink NR RFC transmission; or
the ACK/NACK feedback is associated with a single HARQ-ACK codebook for both the downlink VLC transmission and the downlink NR RFC transmission, wherein a downlink assignment indicator that is indexed based at least in part on a slot beginning boundary is separately indexed for the downlink VLC transmission and the downlink NR RFC transmission.

30. The method of claim 25, wherein a hybrid automatic repeat request (HARQ)-ACK codebook type is separately configured for the downlink VLC transmission and the downlink NR RFC transmission based at least in part on the ACK/NACK feedback being a layer 1 ACK/NACK feedback, and wherein two separate HARQ-ACK codebooks are fed back via the uplink RF transmission and include:
a dynamic codebook for the downlink NR RFC transmission and a semi-static codebook for the downlink VLC transmission;
a dynamic codebook for the downlink NR RFC transmission and a dynamic codebook for the downlink VLC transmission;
a semi-static codebook for the downlink NR RFC transmission and a semi-static codebook for the downlink VLC transmission; or
a semi-static codebook for the downlink NR RFC transmission and a dynamic codebook for the downlink VLC transmission.
